(19) United States
(12) Patent Application Publication
(10) Pub. No.: US 2023/0288922 A1
(43) Pub. Date: Sep. 14, 2023

(54) INTEGRATED CONTROL APPARATUS FOR AUTONOMOUS DRIVING VEHICLE

(71) Applicants: Hyundai Motor Company, Seoul (KR); Kia Corporation, Seoul (KR)

(72) Inventor: Eun Sik Kim, Gwangmyeong (KR)

(21) Appl. No.: 17/948,643

(22) Filed: Sep. 20, 2022

(30) Foreign Application Priority Data
Mar. 10, 2022 (KR) 10-2022-0030154

(51) Int. Cl. G05D 1/00

(52) U.S. Cl. CPC G05D 1/0016; G05D 1/0061; G05D 2201/0213

(57) ABSTRACT

An integrated control apparatus for an autonomous driving vehicle is provided. The integrated control apparatus is provided in an autonomous driving vehicle, and is a device operated by a user in a manual driving mode for steering, accelerating, deaccelerating, and braking, and an acceleration actuator and a brake actuator are provided together in a housing performing steering operation, so that acceleration, brake, and steering functions that are used by the user often are integrated in one integrated control apparatus, and a shift function that is not used often is separated from the integrated control device, thereby securing the stability of operation is secured.

### CROSS REFERENCE TO RELATED APPLICATION

The present application claims priority to Korean Patent Application No. 10-2022-0030154, filed Mar. 10, 2022, the entire contents of which is incorporated herein for all purposes by this reference.

### 1. FIELD

The present disclosure relates to an integrated control apparatus for an autonomous driving vehicle and, more particularly, to an integrated control apparatus provided in an autonomous driving vehicle, the integrated control apparatus being configured to be directly operated by a user when the vehicle is turned from an autonomous driving mode to a manual driving mode.

### 2. BACKGROUND

An autonomous driving vehicle refers to a smart vehicle incorporating autonomous driving technology that allows the vehicle to find its own destination without an operator directly operating the steering wheel, accelerator pedal, or brake.

When the autonomous driving situation is universally realized, a manual driving mode in which the operator directly drives and an autonomous driving mode in which the vehicle drives to its own destination without the operator directly driving may be selected.

Meanwhile, in the case of the manual driving mode, a drive-by-wire system is being actively developed to improve safety and convenience of operation. Therefore, an autonomous driving vehicle is being developed in technology of apparatus that is configured compact with a minimum layout of acceleration, brake, and steering devices in the manual driving mode.

As an example, when a vehicle manager (operator) operates the vehicle in the manual driving mode using a device such as a joystick used in a game machine, a number of switches using buttons, levers, and toggles are arranged in a complex form on one joystick device. Therefore, operation of the device is difficult and inconvenient, and in particular, there is a risk of mis-operation.

In addition, a conventional integrated control apparatus has a configuration in which only some functions of an acceleration function, a brake function, and a steering function frequently used by an operator are integrated, thereby causing a disadvantage in a layout of the vehicle.

Furthermore, the conventional integrated control apparatus has a steering function that is small in actual operation displacement of the user, thereby causing a disadvantage that operation thereof is not easy.

The foregoing is intended merely to aid in the understanding of the background of the present disclosure, and is not intended to mean that the present disclosure falls within the purview of the related art that is already known to those skilled in the art.

### SUMMARY

Accordingly, the present disclosure has been made keeping in mind the above problems occurring in the related art, and the present disclosure is intended to an integrated control apparatus provided in an autonomous driving vehicle, wherein the integrated control apparatus is configured to improve the convenience of operation and to prevent mis-operation as much as possible, so that a user operates the integrated control apparatus when the vehicle is turned from an autonomous driving mode to a manual driving mode.

In one aspect, an integrated control apparatus is provided in an autonomous driving vehicle, wherein an acceleration function, a brake function, and a steering function frequently used by an operator are integrated in one integrated control apparatus, and a shift function that is not used by the user often is separated from the integrated control apparatus, thereby securing the safety of operation and being advantageous in a layout of a vehicle.

In a further aspect, an integrated control apparatus is provided in an autonomous driving vehicle, wherein a steering function that requires large displacement is configured to have large operable displacement, thereby improving the convenience of operation.

In one aspect, an integrated control apparatus for an autonomous driving vehicle, the integrated control apparatus comprising: a) a steering device configured to be coupled to a mounting surface inside the vehicle to be rotatable, and configured to generate a steering signal when being held by a hand of a user and rotation-operated clockwise or counterclockwise; and b) an acceleration actuator and a brake actuator associated with the steering device. In certain aspects, the steering device is configured to be rotatable on a steering pin clockwise and counterclockwise.

In a further aspect, there is provided an integrated control apparatus for an autonomous driving vehicle, the integrated control apparatus comprising: a steering device configured to be coupled to a mounting surface inside the vehicle to be rotatable on a steering pin clockwise and counterclockwise, and configured to generate a steering signal when being held by a hand of a user and rotation-operated clockwise or counterclockwise; and an acceleration actuator (e.g. button) and a brake actuator (e.g. button) provided in the steering device.

The steering device may suitably comprise: a housing that suitable comprises the steering pin, and the acceleration actuator (e.g. button) and the brake actuator (e.g. button), and configured to be rotatably operated while the user grips the housing with the user's hand; a steering magnet provided in the housing; and a first printed circuit board (PCB) provided in the mounting surface to face the steering magnet, and generating a signal related to steering by recognizing magnetic flux change in response to a change in position of the steering magnet when the housing is rotated on the steering pin.

The steering pin suitably may be coupled to a nut after passing through the mounting surface and configured to prevent separation thereof from the mounting surface.

The steering device suitably may comprise: a steering recovery spring configured to provide a recovery force to the rotated housing while opposite ends thereof are respectively coupled to the mounting surface and the steering pin.

The housing suitably may comprise: a support part configured for the hand of the user to be placed thereon, and including the steering pin at a lower portion thereof; and an extension part extended forward of the support part, and including the acceleration actuator and the brake actuator at a front surface and a side surface, respectively.

The housing suitably may comprise: a guide part protruding upward from left and right portions of the support part.

The steering device may be configured to rotation-operate the housing clockwise or counterclockwise on the steering pin while the user places the hand on the support part of the housing.

The acceleration actuator (e.g. button) may be a rotation lever button, which may be coupled to a front surface of the housing such that an upper end thereof may be rotatable on a shaft with respect to the housing and a lower end thereof may be swung forward and rearward around the shaft.

The integrated control apparatus suitably may comprise: an acceleration recovery spring configured to provide a recovery force to the rotated acceleration actuator while opposite ends thereof are respectively supported by the housing and the acceleration actuator.

The acceleration actuator (e.g. button) may be operated as the user pushes the acceleration button with a finger of the hand that grips the housing, and when the user releases an operation force, the acceleration actuator may be recovered to an initial position by a spring force of the acceleration recovery spring.

When the user pushes the acceleration actuator button for operation, acceleration may be performed, and when the user releases an operation force, deacceleration may be performed while the acceleration actuator is recovered to an initial position by a spring force of the acceleration recovery spring.

The acceleration actuator (e.g. button) may be coupled to a front surface of the housing such that an upper end thereof may be rotatable and the housing may cover the acceleration actuator in an non-operation state of the user to prevent the acceleration actuator from protruding forward of the housing.

The brake actuator (button) may be a horizontal motion button provided at a first lateral surface of the housing and configured to be moved in a horizontal direction in operation of the user.

The integrated control apparatus suitably may comprise: a housing partition wall securely provided at a position of the housing, the position facing the brake actuator; and a brake recovery spring configured to provide a recovery force to the operated brake actuator while opposite ends thereof are respectively supported by the brake button and the housing partition wall.

The brake actuator (e.g. button) may be operated as the user pushes the brake actuator with a finger of the hand that grips the housing, and when the user releases an operation force, the brake actuator may be recovered to an initial position by a spring force of the brake recovery spring.

The integrated control apparatus may include: an acceleration magnet provided in the acceleration actuator; a brake magnet provided in the brake actuator; and a second printed circuit board (PCB) provided in the housing to face both the acceleration magnet and the brake magnet, and generating a signal related to acceleration by recognizing magnetic flux change in response to a change in position of the acceleration magnet when the acceleration actuator is operated, and generating a signal related to brake by recognizing magnetic flux change in response to a change in position of the brake magnet when the brake actuator is operated.

When both the acceleration actuator and the brake actuator are operated at the same time and thus the two signals are generated, the second PCB may recognize the brake signal preferentially and ignore the acceleration signal.

The acceleration actuator and the brake actuator may have different operation positions and methods to prevent mis-operation.

A shift actuator (e.g. button) serving a shift function of a vehicle may be separated from the steering device with the acceleration actuator and the brake actuator and be provided at a position spaced apart from the steering device.

The shift actuator may be provided at the mounting surface with the steering device at a spacing from the steering device so as to prevent interference between the shift actuator and the steering device or be provided in at least one of positions in a vehicle seat, a cluster, an AVN, a console, and a door-side inside space.

The integrated control apparatus for an autonomous driving vehicle according to the present disclosure is provided in an autonomous driving vehicle, and is a device that is operated by the user for steering, accelerating, deaccelerating, and braking in the manual driving mode. Therefore, the operation of the integrated control apparatus is easy and convenient, and intuition in the operation is increased to prevent mis-operation as much as possible.

Furthermore, the integrated control apparatus of the present disclosure includes the acceleration actuator and the brake actuator, which are provided together in the housing performing steering operation, so that acceleration function, brake function, and steering function that the user uses often are integrated in the one integrated control apparatus, and the shift function that the user does not use often is separated from the integrated control apparatus so that the safety of operation can be secured.

Furthermore, the integrated control apparatus of the present disclosure is configured to rotate the entire housing on the steering pin by wrist rotation of the user to perform steering operation, and in a case of the steering function that requires large displacement, operable displacement may be largely implemented, so that convenience of operation can be improved.

Furthermore, the integrated control apparatus of the present disclosure is configured to have the acceleration actuator and the brake actuator provided in the steering device with different positions and methods of operation, so that mis-operation can be prevented as much as possible.

In further aspects, vehicles are provided that comprise a integrated control apparatus as disclosed herein.

In a fully autonomous vehicle or system, the vehicle may perform all driving tasks under all conditions and little or no driving assistance is required a human driver. In semi-autonomous vehicle, for example, the automated driving system may perform some or all parts of the driving task in some conditions, but a human driver regains control under some conditions, or in other semi-autonomous systems, the vehicle's automated system may oversee steering and accelerating and braking in some conditions, although the human driver is required to continue paying attention to the driving environment throughout the journey, while also performing the remainder of the necessary tasks.

In certain embodiments, the present systems and vehicles may be fully autonomous. In other certain embodiments, the present systems and vehicles may be semi-autonomous.

Other aspects are disclosed infra.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is an exploded-perspective view showing an integrated control apparatus according to the present disclosure;

FIG. 2 is a perspective view showing an assembled state of FIG. 1;

FIGS. 3 to 5 are plan, side, and bottom views of FIG. 2;

FIG. 6 is a view showing a steering device according to the present disclosure without a cover of a housing;

FIG. 7 is a plan view of FIG. 6;

FIG. 8 is a view showing the steering device according to the present disclosure on which a hand of a user is placed; and

FIGS. 9 to 10 are views showing a separated structure of the steering device and a shift actuator according to the present disclosure.

### DETAILED DESCRIPTION

In the following description, the structural or functional description specified to exemplary embodiments according to the concept of the present disclosure is intended to describe the exemplary embodiments, so it should be understood that the present disclosure may be variously embodied, without being limited to the exemplary embodiments.

Embodiments described herein may be changed in various ways and various shapes, so specific embodiments are shown in the drawings and will be described in detail in this specification. However, it should be understood that the exemplary embodiments according to the concept of the present disclosure are not limited to the embodiments which will be described hereinbelow with reference to the accompanying drawings, but all of modifications, equivalents, and substitutions are included in the scope and spirit of the disclosure.

It will be understood that, although the terms first and/or second, etc. may be used herein to describe various elements, these elements should not be limited by these terms. These tams are only used to distinguish one element, from another element. For instance, a first element discussed below could be termed a second element without departing from the teachings of the present disclosure. Similarly, the second element could also be termed the first element.

It is to be understood that when one element is referred to as being “connected to” or “coupled to” another element, it may be connected directly to or coupled directly to another element or be connected to or coupled to another element, having the other element intervening therebetween. On the other hand, it is to be understood that when one element is referred to as being “connected directly to” or “coupled directly to” another element, it may be connected to or coupled to another element without the other element intervening therebetween. Further, the terms used herein to describe a relationship between elements, that is, “between”, “directly between”, “adjacent”, or “directly adjacent” should be interpreted in the same manner as those described above.

The terminology used herein is for the purpose of describing particular embodiments only and is not intended to limit the present disclosure. Singular forms are intended to include plural forms unless the context clearly indicates otherwise. It will be further understood that the terms “comprises” or “have” used in this specification, specify the presence of stated features, steps, operations, components, parts, or a combination thereof, but do not preclude the presence or addition of one or more other features, numerals, steps, operations, components, parts, or a combination thereof.

Unless otherwise defined, all terms including technical and scientific terms used herein have the same meaning as commonly understood by those skilled in the art to which the present disclosure belongs. It must be understood that the terms defined by the dictionary are identical with the meanings within the context of the related art, and they should not be ideally or excessively formally defined unless the context clearly dictates otherwise.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

According to the exemplary embodiment of the present disclosure, a controller may be realized by a nonvolatile memory (not shown), which consists of an algorithm configured to control operations of various components of a vehicle or data regarding software instructions to play the algorithm, and a processor (not shown), which is configured to perform operations described below using the data stored in the memory. The memory and processor may be realized as separate chips. Alternately, the memory and processor may be realized as an integrated single chip. The processor may have one or more forms.

Hereinbelow, an integrated control apparatus for an autonomous driving vehicle according to a preferred embodiment of the present disclosure will be described with reference to accompanying drawings.

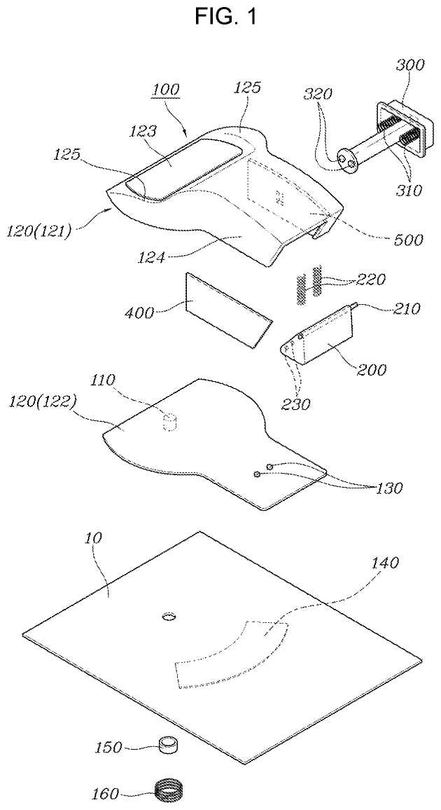

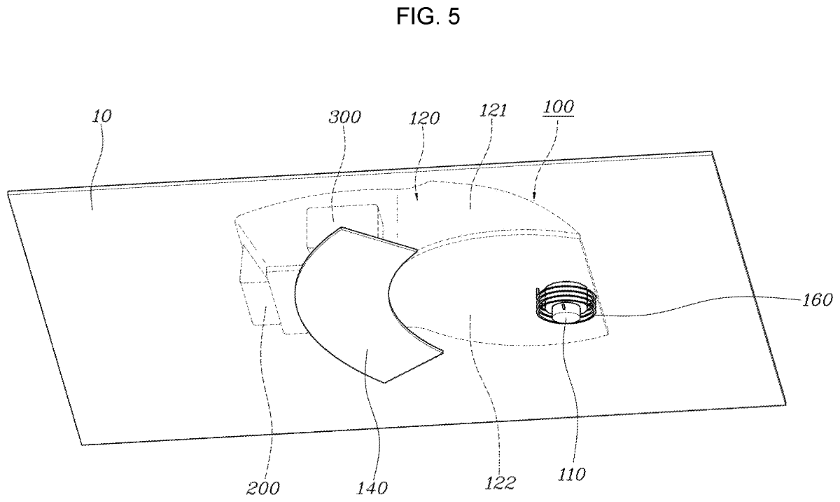

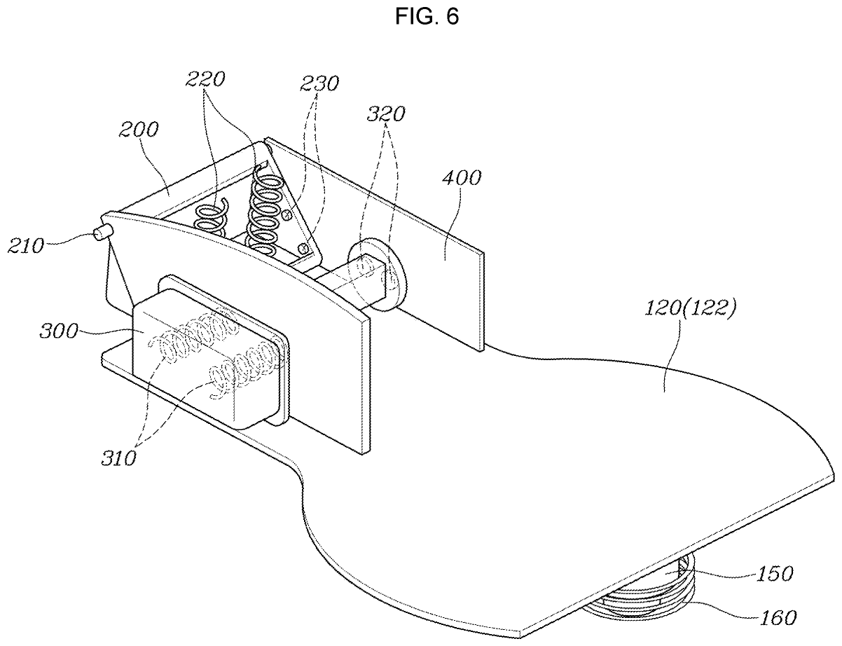

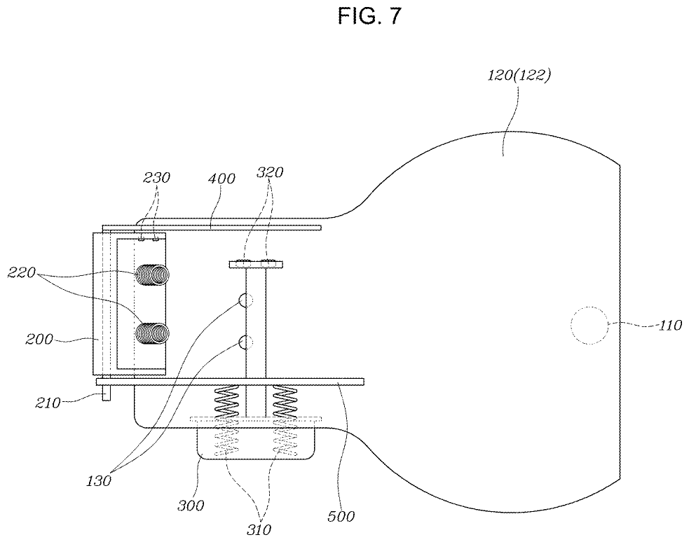

According to the present disclosure, as shown in FIGS. 1 to 10, the integrated control apparatus for an autonomous driving vehicle is provided in an autonomous driving vehicle, and is an apparatus that is operated by a vehicle occupant (operator) to drive the vehicle in a manual driving mode.

According to the present disclosure, the integrated control apparatus for an autonomous driving vehicle operated by a user in the manual driving mode includes: a steering device 100 coupled to a mounting surface 10 in the inside space of the vehicle to be rotatable clockwise and counterclockwise on a steering pin 110, and generating a steering signal when the user (operator) grips the steering device 100 with a hand and performs rotatable-operation clockwise and counterclockwise; and an acceleration actuator 200 and a brake actuator 300 provided at the steering device 100.

The mounting surface 10 inside the vehicle may be any one of a console, a seat, and a center fascia, and may be other locations where an operator can reach out hands of the operator.

The steering device 100 is a device that is gripped and rotatably operated with the user's hand, and generates a signal related to steering in rotatable operation.

In a preferred configuration, the steering device 100 includes the acceleration actuator 200 and the brake actuator 300 that are operated by a finger of the user, and a signal related to acceleration or brake of the vehicle is generated when the acceleration actuator 200 or the brake actuator 300 is operated.

In a preferred configuration, the steering device 100 includes: a housing 120 including the steering pin 110, and the acceleration button 200 and the brake actuator 300, and rotatably operated while the user grips the housing 120 with a user's hand; a steering magnet 130 provided in the housing 120; and a first printed circuit board (PCB) 140 provided in the mounting surface 10 to face the steering magnet 130, and generating a signal related to steering by recognizing magnetic flux change in response to a change in position of the steering magnet 130 when the housing 120 is rotated on the steering pin 110.

The housing 120 includes a cover 121 and a lower plate 122 that are coupled to each other to be vertically separable, the steering pin 110 is provided to protrude downward on a rear-side lower surface of the lower plate 122, and a plurality of steering magnets 130 is securely provided at a front portion of the lower plate 122.

The first PCB 140 is extended in a movement direction of the steering magnet 130 moving on the steering pin 110 as the center, and is provided at a lower surface of the mounting surface 10 to face the steering magnet 130.

The steering pin 110 provided in the housing 120 passes through the mounting surface 10 and then protrudes downward. An end of the steering pin 110 passing through the mounting surface 10 is coupled to a nut 150, and coupling between the steering pin 110 and the nut 150 prevents the steering pin 110 from separated from the mounting surface 10, so that it is possible to prevent the housing 120 from being separated from the mounting surface 10.

According to the present disclosure, the steering device 100 includes a steering recovery spring 160 generating a recovery force to the rotated housing 120 while opposite ends thereof are respectively coupled to the mounting surface 10 and the steering pin 110.

The housing 120 includes: a support part 123 to which the user's hand is placed, and including the steering pin 110 at a lower portion thereof; and an extension part 124 extended forward of the support part 123, and including the acceleration actuator 200 and the brake actuator 300 at a front surface and a side surface, respectively.

Both the support part 123 and the extension part 124 are provided in the cover 121 of the housing 120, and the support part 123 is provided at a rear-side upper surface of the cover 121, and the extension part 124 is extended forward of the support part 123.

The support part 123 is a location on which a palm of the user's hand is placed, and the user operates the acceleration actuator 200 and the brake actuator 300 by a finger of the user's hand on the support part 123.

A guide part 125 is provided to protrude upward on left and right portions of the support part 123, and the guide part 125 supports the user's hand placed on the support part 123 to prevent the user's hand from slipping and being separated from the support part 123, so that stable operation is possible.

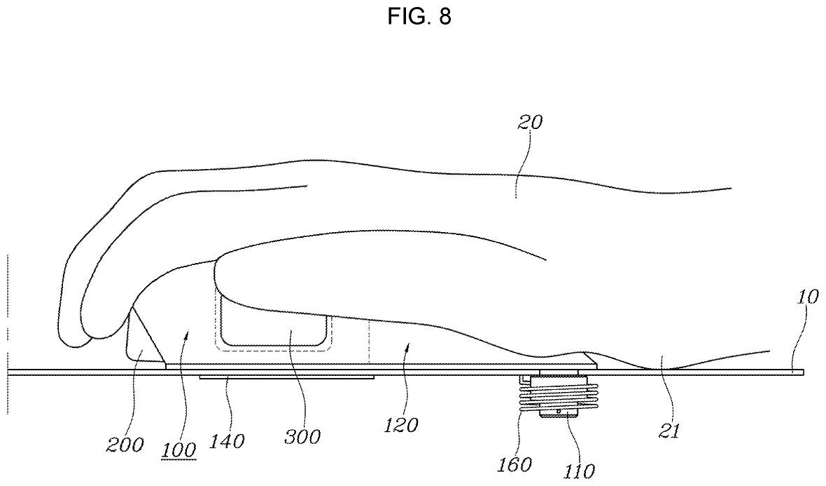

The palm of the user's hand 20 is placed on the support part 123 of the housing 120 as shown in FIG. 8, and fingers of the hand 20 are positioned to operate the acceleration actuator 200 or the brake actuator 300.

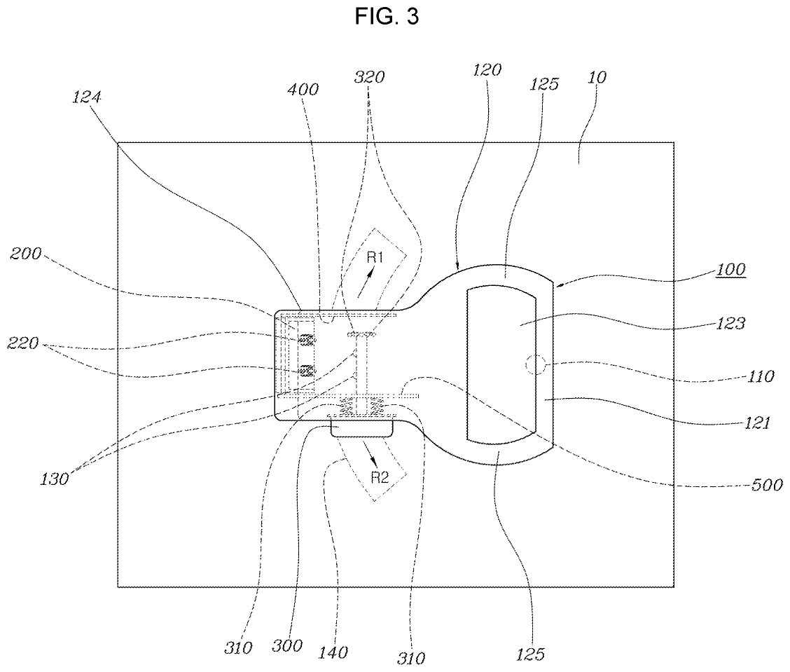

When the user operates the housing 120 clockwise or counterclockwise while placing the palm on the support part 123 of the housing 120, the housing 120 is rotated clockwise or counterclockwise on the steering pin 110 (arrows R1 and R2 in FIG. 3), and when the housing 120 is rotated, the first PCB 140 recognizes magnetic flux change in response to a change in position of the steering magnet 130 to generate a signal related to steering.

When the user places the user's palm on the support part 123 of the housing 120, as shown in FIG. 8, a rear portion 21 of the user's palm is brought into contact with the mounting surface 10, and when the user rotates the housing 120 clockwise or counterclockwise, the rear portion 21 of the user's palm serves as a rotation center of the user's hand 20.

The embodiment of the present disclosure is configured to perform steering operation by rotating the entire housing 120 on the steering pin 110 by wrist rotation of the user, and to realize large displacement in operation in the steering function that requires large displacement, so that there is an advantage of improving the convenience of operation thereof.

In a preferred configuration, the acceleration actuator 200 is a rotation lever button, which is coupled to a front surface of the housing 120 such that an upper end thereof is rotatable on a shaft 210 with respect to the housing 120 and a lower end thereof is swung forward and rearward around the shaft 210 of the upper end.

In a preferred configuration, the acceleration actuator 200 is operated by a finger of the user's hand 20 placed on the support part 123 of the housing 120, and preferably, as shown in FIG. 8, is operated with the index, middle and ring finger, so that precise control with small displacement is possible.

According to the embodiment of the present disclosure, the integrated control apparatus includes an acceleration recovery spring 220 providing a recovering force to the rotated acceleration actuator 200 while opposite ends thereof are respectively supported by the housing 120 and the acceleration actuator 200.

The acceleration recovery spring 220 is composed of dual springs, and includes a fail-safe function so that even when any one of the two springs is damaged, the other spring can work normally.

The acceleration actuator 200 is operated as the user pushes the acceleration actuator 200 by the index, middle, and ring fingers of the hand 20 that grips the housing 120, and when an operation force of the user is released, the acceleration actuator 200 is recovered to an initial position by a spring force of the acceleration recovery spring 220.

According to the embodiment of the present disclosure, the integrated control apparatus may be configured to perform acceleration when the user pushes and operates the acceleration actuator 200, and to perform deacceleration as the acceleration actuator 200 is recovered to the initial position thereof by a spring force of the acceleration recovery spring 220 when an operation force is released.

According to the present disclosure, the integrated control apparatus includes: an acceleration magnet 230 provided in the acceleration actuator 200; and a second printed circuit board (PCB) 400 provided in the housing 120 to face the acceleration magnet 230, and generating a signal related to acceleration by recognizing magnetic flux change in response to a change in position of the acceleration magnet 230 when the acceleration actuator 200 is operated.

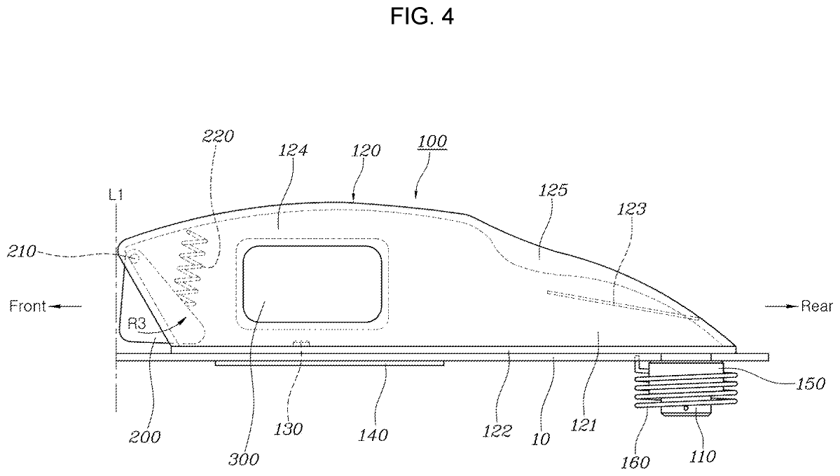

When the user pushes and operates the acceleration button 200, the acceleration actuator 200 is operated such that the lower end thereof is rotated on the shaft 210 at the upper end thereof to be inserted into the housing 120 (arrow R3 in FIG. 4). Herein, the second PCB 400 recognizes the magnetic flux change in response to a change in position of the acceleration magnet 230 to generate a signal corresponding to acceleration, so that acceleration is performed.

Then, in a preferred configuration, when the user releases an operation force from the acceleration actuator 200, the acceleration actuator 200 is reversely rotated by a spring force of the acceleration recovery spring 220 to be recovered to the initial position, and the second PCB 400 recognizes magnetic flux change in response to a change in position of the acceleration magnet 230 to generate a signal corresponding to deacceleration, so that the vehicle performs deacceleration.

When the user does not operate the acceleration actuator 200, the acceleration actuator 200 is blocked by the housing 120 to prevent the acceleration actuator 200 from protruding forward from the housing 120. Therefore, it is possible to prevent the acceleration actuator 200 from being mal-operated by other objects (bag, personal belongings, etc.), not fingers of the user.

The reference numeral L1 in FIG. 4 is a reference line perpendicularly extended from an end of the front surface of the housing 120, and the acceleration actuator 200 is configured to prevent from protruding forward than the reference line L1.

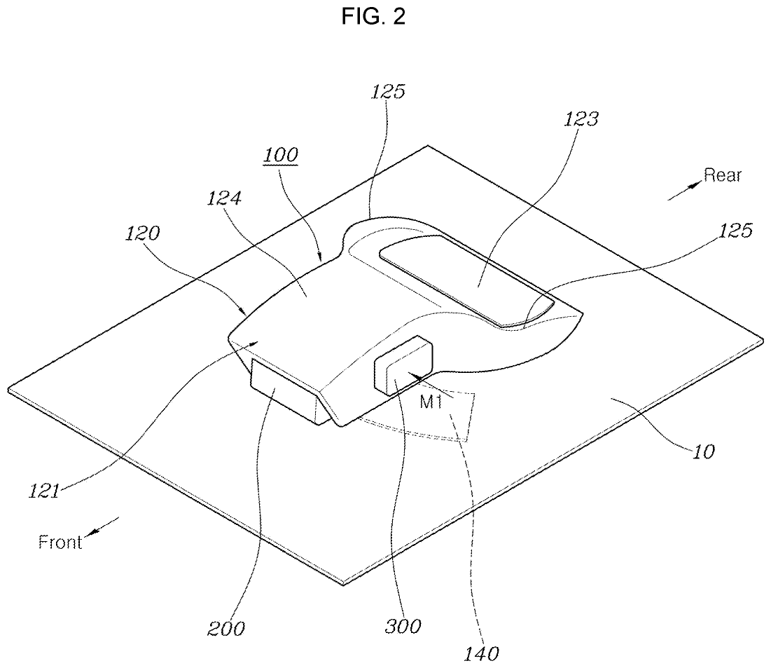

The brake actuator 300 is provided at a side surface of the housing 120 and is a horizontal motion button that moves in a horizontal direction by operation of the user (arrow M1 in FIG. 2).

In a preferred configuration, the brake actuator 300 is suitably operated by a finger of the user's hand 20 placed on the support part 123 of the housing 120, and preferably, by the thumb as shown in FIG. 8, so that the brake actuator 300 can be operated with a large force and precise control of small displacement can be performed.

In a preferred configuration, the brake actuator 300 should be operated quickly with great force compared to the acceleration button 200, and therefore, the brake actuator 300 may be preferably operated by the thumb that generates a large force, and particularly, the brake actuator 300 may be more quickly operated by a structure of the horizontal motion actuator than a structure of the rotation lever actuator.

According to the embodiment of the present disclosure, a housing partition wall 500 is securely provided at a position of the housing 120 facing the brake actuator 300, and the brake actuator 300 includes a brake recovery spring 310 of which opposite ends is supported by the brake actuator 300 and the housing partition wall 500 and providing a recovery force to the brake actuator 300.

The brake recovery spring 310 is composed of dual springs, and includes a fail-safe function so that even when any one of the two springs is damaged, the other spring can work normally.

In a preferred configuration, the brake actuator 300 is operated as the user pushes the acceleration actuator 200 by the thumb of the hand 20 that grips the housing 120, and when an operation force of the user is released, the brake actuator 300 is recovered to an initial position by a spring force of the brake recovery spring 310.

In preferred configuration, the integrated control apparatus includes a brake magnet 320 provided in the brake actuator 300, and the second PCB 400 provided in the housing 120 is configured to face not only the acceleration magnet 230, but also the brake magnet 320, and the second PCB 400 recognizes magnetic flux change in response to a change in position of the brake magnet 320 to generate a signal related to braking, when the brake actuator 300 is operated.

Meanwhile, when the user operates the acceleration actuator 200 and the brake actuator 300 at the same time and two signals are generated, the second PCB 400 recognizes the brake signal preferentially and ignores the acceleration signal, whereby an accident due to mis-operation and sudden acceleration can be prevented.

In preferred configurations, the integrated control apparatus is configured to prevent mis-operation thereof by the acceleration actuator 200 and the brake actuator 300 that have different positions and methods of operation, so that intuition in operation is increased to prevent mis-operation.

In preferred configurations, the acceleration actuator 200 and the brake actuator 300 are provided at the housing 120 accommodating the steering device 100, so that there is an advantage in an aspect of layout of a vehicle as the acceleration, brake, and steering functions frequently used by the user (operator) in the manual driving mode are integrated in one integrated control apparatus.

Furthermore, the shift function that the user does not use often is separated from the integrated control apparatus, so that there is an advantage of ensuring the safety of operation.

In other words, a shift actuator 600 serving a shift function of a vehicle is provided to be separated from the steering device 100 including the acceleration actuator 200 and the brake actuator 300 and provided at a location spaced apart from the steering device 100.

In preferred configurations, the shift actuator 600 includes a P-stage actuator (e.g. button), an R-stage actuator (e.g. button), an N-stage actuator (e.g. button), and a D-stage actuator (e.g. button), and the shift actuator 600 is provided to be separated from the steering device 100 including the acceleration actuator 200 and the brake actuator 300. The user operates the acceleration actuator 200 and the brake actuator 300 including the steering device 100 with one hand (right hand) of the user, and operates the shift button 600 with the other hand (left hand), so that safety of operation can be secured.

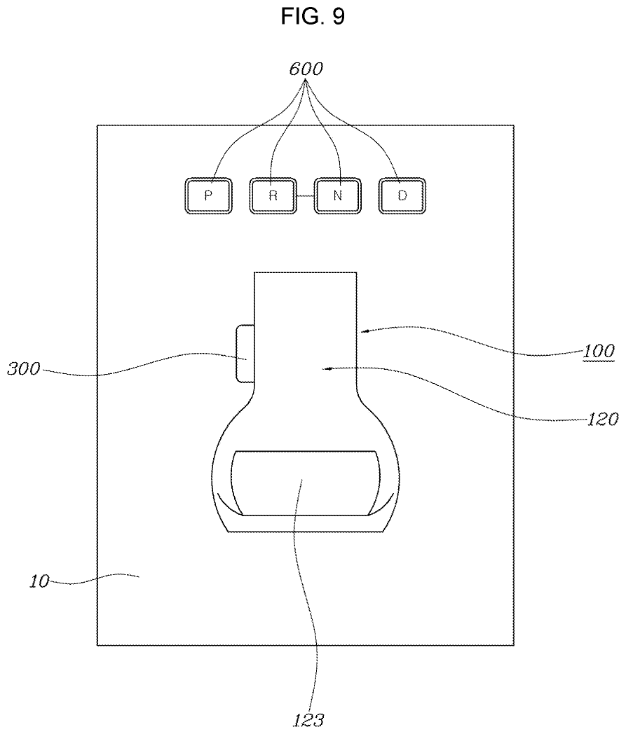

As an example, as shown in FIG. 9, the shift actuator 600 and the steering device 100 including the acceleration actuator 200 and the brake actuator 300 may be provided together on the mounting surface 10 inside the vehicle, but the shift actuator 600 may be provided to be separated from the steering device 100 and to be spaced apart from the steering device 100 to prevent interference therebetween.

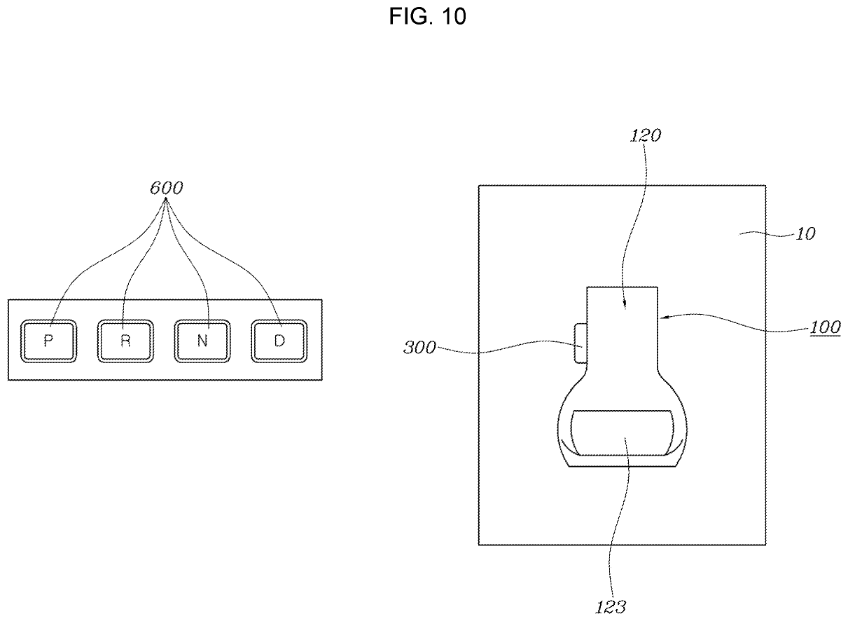

As another example, as shown in FIG. 10, the steering device 100 including the acceleration actuator 200 and the brake actuator 300 are provided on the mounting surface 10 inside the vehicle, and the shift actuator 600 may be separated from the steering device 100 and be located at any one of a vehicle seat, a cluster, an AVN, a console, and a door-side location inside the vehicle.

As another example, the steering device 100 including the acceleration actuator 200 and the brake actuator 300 may be located at a right portion of a vehicle seat, and the shift actuator 600 may be located at a left portion of the vehicle seat.

As described above, the integrated control apparatus for an autonomous driving vehicle according to the present disclosure is provided in an autonomous driving vehicle, and is a device that is operated by the user for steering, accelerating, deaccelerating, and braking in the manual driving mode, and has an advantage in that operation thereof is easy and convenient, and intuition in operation is increased to prevent mis-operation as much as possible.

Furthermore, the integrated control apparatus of the present disclosure includes the acceleration actuator 200 and the brake actuator 300, which are provided together in the housing 120 performing steering operation so that acceleration function, brake function and steering function that the user uses often are integrated in the one integrated control apparatus, and the shift function that the user does not use often is separated from the integrated control apparatus so that the safety of operation can be secured.

Furthermore, the integrated control apparatus of the present disclosure is configured to rotate the entire housing 120 on the steering pin 110 by wrist rotation of the user to perform steering operation, and in a case of the steering function that require large displacement, operable displacement may be largely implemented, so that convenience of operation can be improved.

Furthermore, the integrated control apparatus of the present disclosure is configured to have the acceleration actuator 200 and the brake actuator 300 provided in the steering device 100 with different positions and methods of operation, so that mis-operation can be prevented as much as possible.

Although the preferred embodiment of the present disclosure has been disclosed for illustrative purposes, those skilled in the art will appreciate that various modifications, additions, and substitutions are possible, without departing from the spirit and scope of the present disclosure.

What is claimed is:

1. An integrated control apparatus for an autonomous driving vehicle, the integrated control apparatus comprising:
a steering device configured to be coupled to a mounting surface inside the vehicle to be rotatable, and configured to generate a steering signal when being held by a hand of a user and rotation-operated clockwise or counterclockwise; and
an acceleration actuator and a brake actuator associated with the steering device.

2. The integrated control apparatus of claim 1, wherein the steering device is configured to be rotatable on a steering pin clockwise and counterclockwise.

3. The integrated control apparatus of claim 2, wherein the steering device comprises:
a housing comprising the steering pin, and the acceleration actuator and the brake actuator, and configured to be rotatably operated while the user grips the housing with the user's hand;
a steering magnet provided in the housing; and
a first printed circuit board (PCB) provided in the mounting surface to face the steering magnet, and generating a signal related to steering by recognizing magnetic flux change in response to a change in position of the steering magnet when the housing is rotated on the steering pin.

4. The integrated control apparatus of claim 3, wherein the steering pin is coupled to a nut after passing through the mounting surface and configured to prevent separation thereof from the mounting surface.

5. The integrated control apparatus of claim 3, wherein the steering device further comprises: a steering recovery spring configured to provide a recovery force to the rotated housing while opposite ends thereof are respectively coupled to the mounting surface and the steering pin.

6. The integrated control apparatus of claim 3, wherein the housing comprises: a support part configured for the hand of the user to be placed thereon, and comprising the steering pin at a lower portion thereof; and
an extension part extended forward of the support part, and comprising the acceleration button and the brake button at a front surface and a side surface, respectively.

7. The integrated control apparatus of claim 6, wherein the housing further comprises: a guide part protruding upward from left and right portions of the support part.

8. The integrated control apparatus of claim 6, wherein the steering device is configured to rotation-operate the housing clockwise or counterclockwise on the steering pin while the user places the hand on the support part of the housing.

9. The integrated control apparatus of claim 3, wherein the acceleration actuator is a rotation lever button, which is coupled to a front surface of the housing such that an upper end thereof is rotatable on a shaft with respect to the housing and a lower end thereof is swung forward and rearward around the shaft.

10. The integrated control apparatus of claim 3, further comprising:
an acceleration recovery spring configured to provide a recovery force to the rotated acceleration button while opposite ends thereof are respectively supported by the housing and the acceleration button.

11. The integrated control apparatus of claim 10, wherein the acceleration actuator is operated as the user pushes the acceleration actuator with a finger of the hand that grips the housing, and when the user releases an operation force, the acceleration button is recovered to an initial position by a spring force of the acceleration recovery spring.

12. The integrated control apparatus of claim 10, wherein when the user pushes the acceleration actuator for operation, acceleration is performed, and when the user releases an operation force, deacceleration is performed while the acceleration button is recovered to an initial position by a spring force of the acceleration recovery spring.

13. The integrated control apparatus of claim 3, wherein the acceleration actuator is coupled to a front surface of the housing such that an upper end thereof is rotatable and the housing covers the acceleration actuator in an non-operation state of the user to prevent the acceleration button from protruding forward of the housing.

14. The integrated control apparatus of claim 3, wherein the brake actuator is a horizontal motion actuator provided at a first lateral surface of the housing and configured to be moved in a horizontal direction in operation of the user.

15. The integrated control apparatus of claim 2, further comprising:
a housing partition wall securely provided at a position of the housing, the position facing the brake button; and
a brake recovery spring configured to provide a recovery force to the operated brake actuator while opposite ends thereof are respectively supported by the brake actuator and the housing partition wall; and
the brake actuator is operated as the user pushes the brake button with a finger of the hand that grips the housing, and when the user releases an operation force, the brake actuator is recovered to an initial position by a spring force of the brake recovery spring.

16. The integrated control apparatus of claim 3, further comprising:
an acceleration magnet provided in the acceleration actuator;
a brake magnet provided in the brake button; and
a second printed circuit board (PCB) provided in the housing to face both the acceleration magnet and the brake magnet, and generating a signal related to acceleration by recognizing magnetic flux change in response to a change in position of the acceleration magnet when the acceleration button is operated, and generating a signal related to brake by recognizing magnetic flux change in response to a change in position of the brake magnet when the brake button is operated; and.
when both the acceleration actuator and the brake actuator are operated at the same time and thus the two signals are generated, the second PCB recognizes the brake signal preferentially and ignores the acceleration signal.

17. The integrated control apparatus of claim 1, wherein the acceleration actuator and the brake actuator have different operation positions and methods to prevent mis-operation.

18. The integrated control apparatus of claim 1, wherein a shift actuator serving a shift function of a vehicle is separated from the steering device with the acceleration actuator and the brake actuator and is provided at a position spaced apart from the steering device.

19. The integrated control apparatus of claim 19, wherein the shift actuator is provided at the mounting surface with the steering device at a spacing from the steering device so as to prevent interference between the shift actuator and the steering device or is provided in at least one of positions in a vehicle seat, a cluster, an AVN, a console, and a door-side inside space.

20. A vehicle comprising the integrated control apparatus of claim 1.
